(19) United States
(12) Patent Application Publication
(10) Pub. No.: US 2020/0238826 A1
(43) Pub. Date: Jul. 30, 2020

(54) VEHICLE DISPLAY DEVICE

(71) Applicant: Toyota Jidosha Kabushiki Kaisha, Toyota-shi Aichi-ken (JP)

(72) Inventor: Hiroshi Mizobata, Seto-shi (JP)

(21) Appl. No.: 16/747,840

(22) Filed: Jan. 21, 2020

(30) Foreign Application Priority Data
Jan. 24, 2019 (JP) 2019-010644

(51) Int. Cl. B60K 35/00; G06F 3/01; G06F 3/14

(52) U.S. Cl. CPC B60K 35/00; B60K 2370/152; G06F 3/1446; G06F 3/013

(57) ABSTRACT

A vehicle display device includes a first display section disposed at a vehicle front side of a steering wheel; a second display section disposed in the vicinity of the first display section at a vehicle left side of the first display section, the second display section being oriented toward a driving seat; and a third display section disposed in the vicinity of the first display section at a vehicle right side of the first display section, the third display section being oriented toward the driving seat.

### CROSS-REFERENCE TO RELATED APPLICATION

This application claims priority under 35 USC 119 from Japanese Patent Application No. 2019-010644, filed on Jan. 24, 2019 the disclosure of which is incorporated by reference herein.

### BACKGROUND

### Technical Field

The present disclosure relates to a vehicle display device.

### Related Art

Japanese Patent Application Laid-Open (JP-A) No. 2016-196228 discloses a structure including an in-dash display provided to an instrument panel, and a front display set on a windshield at the vehicle front side of a driving seat. JP-A No. 2016-196228 is configured such that an image display location is switched so as to display an image on the front display during automated driving, and display an image on the in-dash display when the driver is driving.

However, in JP-A No. 2016-196228, the occupant needs to greatly alter their gaze when the images are switched, and so there is room for improvement from the perspective of improving comfort.

### SUMMARY

The present disclosure provides a vehicle display device capable of improving comfort.

A vehicle display device according to a first aspect of the present disclosure includes a first display section disposed at a vehicle front side of a steering wheel; a second display section disposed in the vicinity of the first display section at a vehicle left side of the first display section, the second display section being oriented toward a driving seat; and a third display section disposed in the vicinity of the first display section at a vehicle right side of the first display section, the third display section being oriented toward the driving seat.

In the vehicle display device according to the first aspect of the present disclosure, the first display section is disposed at the vehicle front side of the steering wheel. The second display section is disposed at the vehicle left side of the first display section, and the third display section is disposed at the vehicle right side of the first display section. Note that the second display section and the third display section are disposed in the vicinity of the first display section. This enables a driver (occupant) to view the images displayed on the respective display sections without needing to greatly alter their gaze.

Moreover, the second display section and the third display section are oriented toward the driving seat. This enables the images displayed thereon to be easily viewed by the driver.

In a second aspect of the present disclosure, in the first aspect, the first display section is configured to display a vehicle-rearward image; the second display section may be configured to display a vehicle-left-rearward image; and the third display section may be configured to display a vehicle-right-rearward image.

In the vehicle display device according to the second aspect of the present disclosure, the vehicle-rearward image, the vehicle-left-rearward image, and the vehicle-right-rearward image are displayed close to each other. This enables the driver to ascertain the situation in the surroundings of the vehicle without greatly altering their gaze.

In a third aspect of the present disclosure, in the first aspect or the second aspect, the first display section, the second display section and the third display section partially overlap as viewed from the driving seat, and images displayed at the second display section and the third display section appear continuous with an image displayed at the first display section.

In the vehicle display device according to the third aspect of the present disclosure, the first display section, the second display section, and the third display section may be made to function as one large display section.

A fourth aspect of the present disclosure, in the first aspect or the second aspect, may further include a gaze detection section configured to detect a line of sight of a driver, wherein at least one of the first display section, the second display section, or the third display section is placed in a non-display state and displays an image when a direction of the line of sight detected by the gaze detection section corresponds to the at least one of the first display section, the second display section, or the third display section.

In the vehicle display device according to the fourth aspect of the present disclosure, the driver may be suppressed from finding the display sections overly bright, despite the plural display sections being disposed in front of the driving seat.

A fifth aspect of the present disclosure, in any one of the first aspect to the third aspect, may further include a gaze detection section configured to detect a line of sight of a driver, wherein brightness is increased for the first display section, the second display section, or the third display section, according to a direction of the line of sight detected by the gaze detection section.

In the vehicle display device according to the fifth aspect of the present disclosure, the driver may be suppressed from finding the display sections overly bright, despite the plural display sections being disposed in front of the driving seat.

As described above, the vehicle display device according to the first aspect enables comfort to be improved.

The vehicle display device according to the second aspect enables obstacles in the vehicle surroundings to be checked easily.

The vehicle display device according to the third aspect enables a larger image to be displayed than in cases in which an image is displayed on a single display section.

The vehicle display devices according to the fourth aspect and the fifth aspect enable comfort to be improved.

### BRIEF DESCRIPTION OF THE DRAWINGS

Exemplary embodiments will be described in detail based on the following figures, wherein:

FIG. 1 is a face-on view of a vehicle cabin front section of a vehicle equipped with a vehicle display device according to a first exemplary embodiment;

FIG. 2 is a block diagram illustrating a hardware configuration of a vehicle display device according to the first exemplary embodiment;

FIG. 3 is a face-on view of a vehicle cabin front section of a vehicle equipped with a vehicle display device according to a second exemplary embodiment, in a state in which an image is only being displayed on a first display section;

FIG. 4 is a face-on view of a vehicle cabin front section of a vehicle equipped with a vehicle display device according to the second exemplary embodiment, in a state in which images are being displayed on a first display section and a second display section;

FIG. 5 is a block diagram illustrating a hardware configuration of a vehicle display device according to the second exemplary embodiment; and

FIG. 6 is a face-on view of a vehicle cabin front section of a vehicle equipped with a vehicle display device according to a third exemplary embodiment.

### DETAILED DESCRIPTION

### First Exemplary Embodiment

Explanation follows regarding a vehicle display device 10 according to a first exemplary embodiment, with reference to the drawings. Note that in each of the drawings, the arrow FR indicates a vehicle forward direction, the arrow UP indicates a vehicle upward direction, and the arrow RH indicates a vehicle right side, as appropriate. Unless specifically stated otherwise, in the below explanation, reference to front and rear, left and right, and up and down directions refers to front and rear in a vehicle front-rear direction, left and right in a vehicle width direction, and up and down in a vehicle vertical direction.

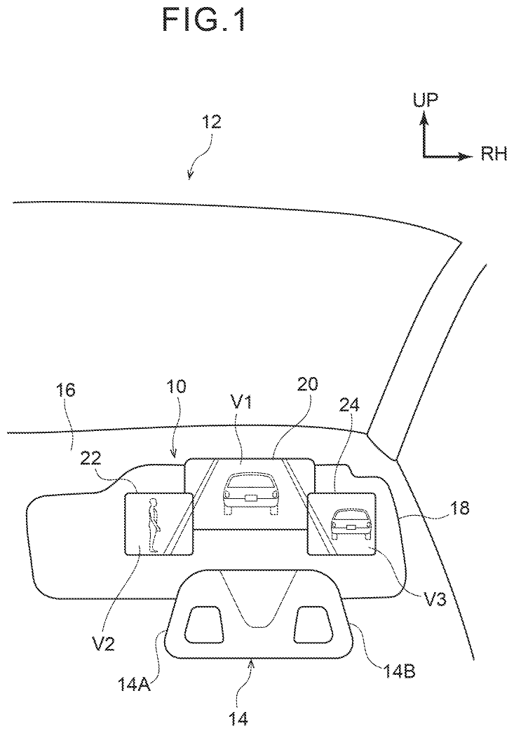

As illustrated in FIG. 1, a steering wheel 14 is provided in a vehicle cabin front section of a vehicle 12 equipped with the vehicle display device 10 according to the present exemplary embodiment.

As an example, the steering wheel 14 of the present exemplary embodiment is what is referred to as an atypically-shaped steering wheel formed in a non-annular shape. The steering wheel 14 is formed such that its length direction runs along the vehicle width direction when not being operated. A left grip portion 14A gripped by the left hand of a driver is provided at a left end portion of the steering wheel 14. A right grip portion 14B gripped by the right hand of the driver is provided at a right end portion of the steering wheel 14.

An instrument panel 16 is provided at the vehicle front side of the steering wheel 14. A non-illustrated shaft (steering shaft) of the steering wheel 14 extends from the instrument panel 16 toward the vehicle rear side, and the steering wheel 14 is rotatably attached to a rear end of the shaft.

A display panel 18 protrudes from the instrument panel 16 toward the vehicle rear side. The length direction of the display panel 18 runs along the vehicle width direction, and the display panel 18 is provided with a first display section 20, a second display section 22, and a third display section 24, which configure the vehicle display device 10.

The first display section 20 is disposed at the vehicle front side of the steering wheel 14, and is positioned in front of the non-illustrated driving seat. A first image V1 is displayed on the first display section 20. In FIG. 1, a rearward image from the vehicle 12 is displayed as the first image V1.

The second display section 22 is disposed at the vehicle left side of the first display section 20. The second display section 22 is disposed in the vicinity of the first display section 20, and is disposed such that the second display section 22 partially overlaps the first display section 20 as viewed from the driving seat in the present exemplary embodiment. Specifically, the second display section 22 is disposed at a position offset toward the vehicle left side and vehicle lower side with respect to the first display section 20, and an upper-right portion of the second display section 22 overlaps a lower-left portion of the first display section 20.

Moreover, the second display section 22 is oriented toward the driving seat. In the present exemplary embodiment, a region of the display panel 18 corresponding to the second display section 22 is curved toward the driving seat such that the second display section 22 is disposed oriented toward the driving seat.

A second image V2 is displayed on the second display section 22. In FIG. 1, a left-rearward image from the vehicle 12 is displayed as the second image V2.

The third display section 24 is disposed at the vehicle right side of the first display section 20. The third display section 24 is disposed in the vicinity of the first display section 20, and is disposed such that the third display section 24 partially overlaps the first display section 20 as viewed from the driving seat in the present exemplary embodiment. Specifically, the third display section 24 is disposed at a position offset toward the vehicle right side and vehicle lower side with respect to the first display section 20, and an upper-left portion of the third display section 24 overlaps a lower-right portion of the first display section 20.

Moreover, the third display section 24 is oriented toward the driving seat. In the present exemplary embodiment, a region of the display panel 18 corresponding to the third display section 24 is curved toward the driving seat such that the third display section 24 is disposed oriented toward the driving seat. Namely, the display panel 18 has a curved shape in which both left and right end portions thereof are positioned toward the vehicle rear side in plan view.

A third image V3 is displayed on the third display section 24. In FIG. 1, a right-rearward image from the vehicle 12 is displayed as the third image V3.

In the present exemplary embodiment, the second image V2 displayed on the second display section 22 and the first image V1 displayed on the first display section 20 are displayed so as to appear continuous to each other. The third image V3 displayed on the third display section 24 and the first image V1 displayed on the first display section 20 are also displayed so as to appear continuous to each other.

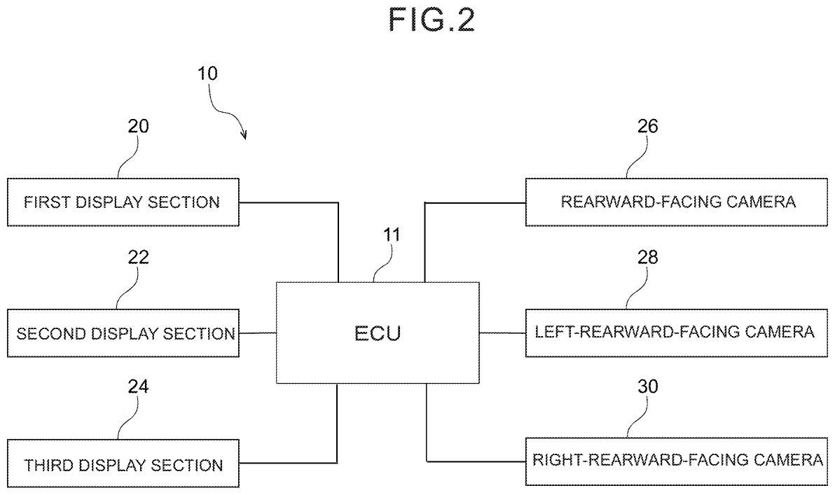

FIG. 2 is a block diagram illustrating a hardware configuration of the present exemplary embodiment. The vehicle display device 10 of the present exemplary embodiment includes an electrical control unit (ECU) 11, this being a controller.

The ECU 11 is electrically connected to the first display section 20, the second display section 22, and the third display section 24. The ECU 11 is also electrically connected to a rearward-facing camera 26, a left-rearward-facing camera 28, and a right-rearward-facing camera 30.

The rearward-facing camera 26 is for example configured including an optical camera provided at a rear section of the vehicle 12, and images toward the rear from the vehicle 12. The left-rearward-facing camera 28 is for example attached to a non-illustrated door mirror provided to a left section of the vehicle 12, and images toward the rear-left from the vehicle 12. The right-rearward-facing camera 30 is for example attached to a non-illustrated door mirror provided to a right section of the vehicle 12, and images toward the rear-right from the vehicle 12.

The vehicle display device 10 of the present exemplary embodiment is configured as described above. The ECU 11 displays a vehicle-rearward image captured by the rearward-facing camera 26 on the first display section 20 as the first image V1. The ECU 11 also displays a vehicle-left-rearward image captured by the left-rearward-facing camera 28 on the second display section 22 as the second image V2. The ECU 11 further displays a vehicle-right-rearward image captured by the right-rearward-facing camera 30 on the third display section 24 as the third image V3. When this is performed, the ECU 11 computes display regions and display positions of the respective images such that the first image V1, the second image V2, and the third image V3 are displayed so as to appear continuous to each other.

Operation

Explanation follows regarding operation of the present exemplary embodiment.

As illustrated in FIG. 1, in the vehicle display device 10 according to the present exemplary embodiment, the first display section 20 is disposed at the vehicle front side of the steering wheel 14, and the second display section 22 is disposed at the vehicle left side of the first display section 20. The third display section 24 is disposed at the vehicle right side of the first display section 20, and the second display section 22 and the third display section 24 are disposed in the vicinity of the first display section 20. This enables the driver (occupant) to view the images displayed on the respective display sections without needing to greatly alter their gaze.

In the present exemplary embodiment, the second display section 22 and the third display section 24 are oriented toward the driving seat. This enables the images displayed thereon to be easily viewed by the driver, enabling comfort to be improved. Namely, in a configuration in which the display panel 18 is formed in a linear shape that is not curved in plan view, the second display section 22 and the third display section 24 would be oriented toward the vehicle rear and so might be difficult for the driver to view. In contrast thereto, in the vehicle display device 10 of the present exemplary embodiment, the second display section 22 and the third display section 24 are oriented toward the driving seat, and so the driver may easily view the second image V2 or the third image V3 when looking at the second display section 22 or the third display section 24 without greatly altering their gaze.

Further, in the present exemplary embodiment, a vehicle-rearward image is displayed on the first display section 20, a vehicle-left-rearward image is displayed close by on the second display section 22, and a vehicle-right-rearward image is displayed close by on the third display section 24. This enables the driver to ascertain the situation in the surroundings of the vehicle 12 without greatly altering their gaze. Namely, the driver is able to easily check obstacles in the surroundings of the vehicle 12.

Further, in the present exemplary embodiment, the first image V1, the second image V2, and the third image V3 are displayed so as to appear continuous to each other, thereby enabling the first display section 20, the second display section 22, and the third display section 24 to be made to function as one large display section. This enables a larger image to be displayed than in configurations in which images are displayed on a single display section.

### Second Exemplary Embodiment

Explanation follows regarding a vehicle display device 40 according to a second exemplary embodiment. Note that similar configurations to those in the first exemplary embodiment are appended with the same reference numerals and explanation thereof is omitted as appropriate.

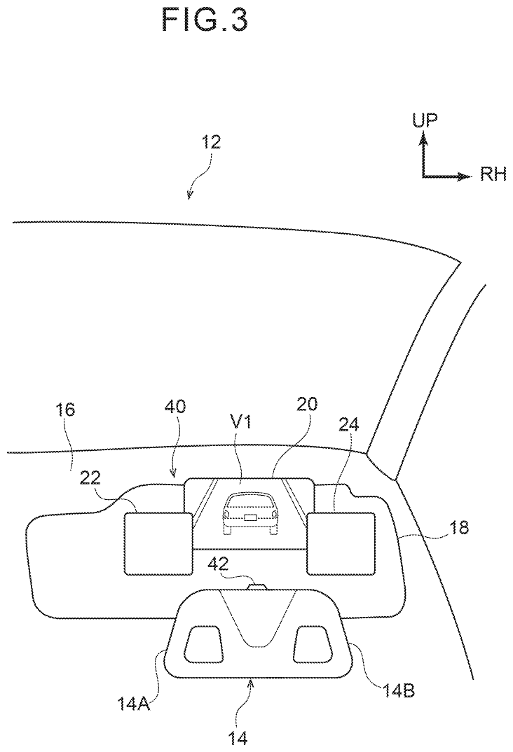

As illustrated in FIG. 3, the steering wheel 14 is provided in the vehicle cabin front section of the vehicle 12 equipped with the vehicle display device 40 according to the present exemplary embodiment. The display panel 18 protrudes from the instrument panel 16 toward the vehicle rear side, and is provided with the first display section 20, the second display section 22, and the third display section 24.

Note that in FIG. 3, although the first image V1 is displayed on the first display section 20, images are not displayed on the second display section 22 or the third display section 24. Namely, the second display section 22 and the third display section 24 are in non-display states.

A gaze detection sensor 42, serving as a gaze detection section, is provided at an upper end portion of the steering wheel 14. The gaze detection sensor 42 faces toward the head of the driver seated in the driving seat, and is configured so as to be capable of detecting the direction of the gaze of the driver.

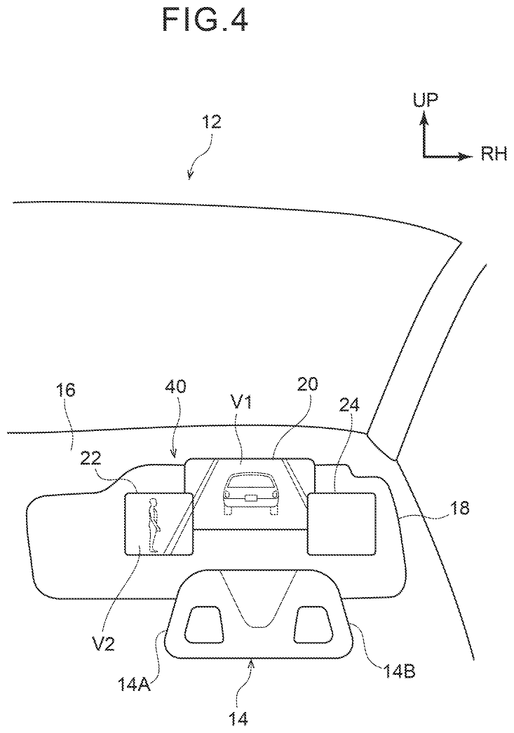

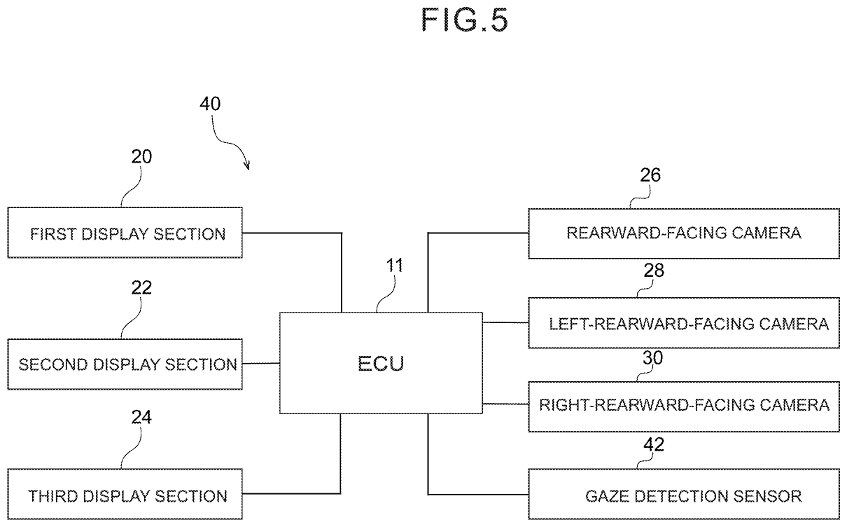

FIG. 5 is a block diagram illustrating a hardware configuration of the present exemplary embodiment. The ECU 11 configuring the vehicle display device 40 of the present exemplary embodiment is electrically connected to the gaze detection sensor 42. When the gaze detection sensor 42 detects that the gaze of the driver is directed toward the second display section 22, the ECU 11 displays the second image V2 on the second display section 22 (see FIG. 4). When the gaze detection sensor 42 detects that the gaze of the driver is directed toward the third display section 24, the ECU 11 displays the third image V3 on the third display section 24 (see FIG. 1).

Operation

Explanation follows regarding operation of the present exemplary embodiment.

In the vehicle display device 40 according to the present exemplary embodiment, when the driver is looking ahead of the vehicle through the windshield while driving, the second display section 22 and the third display section 24 are in non-display states, as illustrated in FIG. 3. Namely, only the first image V1 is displayed, on the first display section 20.

When the driver then directs their gaze toward the second display section 22, the gaze detection sensor 42 detects that the driver has directed their gaze toward the second display section 22. The second image V2 is accordingly displayed on the second display section 22 based on a signal from the ECU 11. Note that the second image V2 continues to be displayed for a predetermined duration after the driver has shifted their gaze away from the second display section 22.

Similarly, when the driver directs their gaze toward the third display section 24, the third image V3 is displayed on the third display section 24 for a predetermined duration based on a signal from the ECU 11.

As described above, in cases in which the gaze of the driver is directed toward neither the second display section 22 nor the third display section 24, an image is only displayed on the first display section 20. This enables the driver to be suppressed from finding the display sections overly bright, despite the plural display sections being disposed in front of the driving seat. Comfort may be improved as a result.

### Third Exemplary Embodiment

Explanation follows regarding a vehicle display device 50 according to a third exemplary embodiment. Note that similar configurations to those in the first exemplary embodiment and second exemplary embodiment are appended with the same reference numerals and explanation thereof is omitted as appropriate.

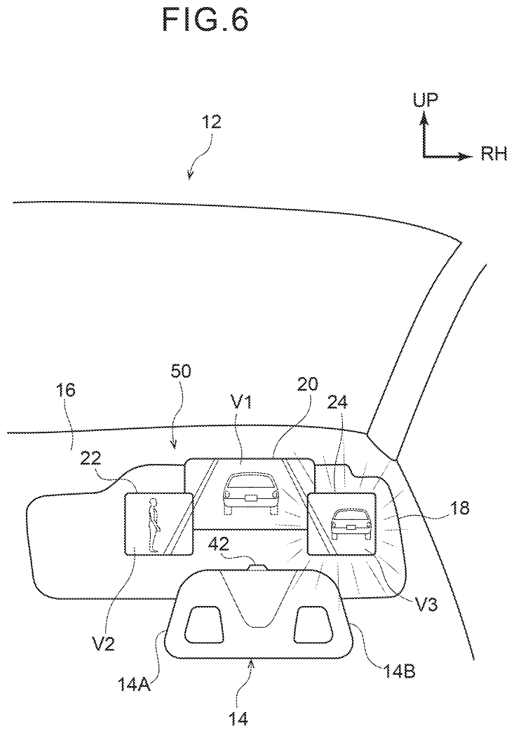

As illustrated in FIG. 6, the steering wheel 14 is provided in the vehicle cabin front section of the vehicle 12 equipped with the vehicle display device 50 according to the present exemplary embodiment. The display panel 18 protrudes from the instrument panel 16 toward the vehicle rear side, and is provided with the first display section 20, the second display section 22, and the third display section 24.

The first image V1 is displayed on the first display section 20, the second image V2 is displayed on the second display section 22, and the third image V3 is displayed on the third display section 24.

The gaze detection sensor 42 is provided at the upper end portion of the steering wheel 14. The gaze detection sensor 42 faces toward the head of the driver seated in the driving seat, and is configured so as to be capable of detecting the direction of the gaze of the driver.

A hardware configuration of the present exemplary embodiment is similar to that in the block diagram illustrated in FIG. 5. Namely, the ECU 11 is electrically connected to the gaze detection sensor 42. Note that when the gaze detection sensor 42 detects that the gaze of the driver is directed toward the second display section 22, the ECU 11 increases the brightness of the second display section 22. When the gaze detection sensor 42 detects that the gaze of the driver is directed toward the third display section 24, the ECU 11 increases the brightness of the third display section 24. FIG. 6 illustrates a state in which the driver has directed their gaze toward the third display section 24, and the third display section 24 is set to a brighter state than the first display section 20 and the second display section 22.

Operation

Explanation follows regarding operation of the present exemplary embodiment.

In the vehicle display device 50 according to the present exemplary embodiment illustrated in FIG. 6, when the driver is looking ahead of the vehicle through the windshield while driving, the first display section 20, the second display section 22, and the third display section 24 have a uniform brightness. Note that this brightness is lower than in the first exemplary embodiment and the second exemplary embodiment. This enables the driver to be suppressed from finding the display sections overly bright.

When the driver then directs their gaze toward the third display section 24, the gaze detection sensor 42 detects that the driver has directed their gaze toward the third display section 24. The third image V3 is thereby displayed in a state in which the brightness of the third display section 24 is increased based on a signal from the ECU 11. Note that the state in which the brightness of the third image V3 is increased is continued for a predetermined duration after the driver has shifted their gaze away from the third display section 24.

Similarly, when the driver directs their gaze toward the second display section 22, the second image V2 is displayed in a state in which the brightness of the second display section 22 is increased based on a signal from the ECU 11. Namely, the second image V2 on the second display section 22 becomes brighter than the first image V1 and the third image V3.

As described above, the brightness of the first display section 20, the second display section 22, or the third display section 24 is raised when being subjected the gaze of the driver. This enables the driver to be suppressed from finding the display sections overly bright, despite the plural display sections being disposed in front of the driving seat. Comfort may be improved as a result.

Vehicle display devices according to the first exemplary embodiment to the third exemplary embodiment have been described above. However, obviously various configurations may be implemented within a range not departing from the spirit of the present disclosure. For example, although the second display section is disposed at a position offset toward the vehicle left side and vehicle lower side with respect to the first display section 20 in the above exemplary embodiments as illustrated in FIG. 1, there is no limitation thereto. Namely, the second display section 22 may be disposed at the same height as the first display section 20 in the vehicle vertical direction. Similarly, the third display section 24 may disposed at the same height as the first display section 20 in the vehicle vertical direction.

Moreover, there is no particular limitation to the sizes and shapes of the first display section 20, the second display section 22, and the third display section 24. For example, the first display section 20, the second display section 22, and the third display section 24 may all be the same size. The first display section 20, the second display section 22, and the third display section 24 may also be formed in circular or polygonal shapes.

Further, although the steering wheel 14 is an atypically-shaped steering wheel with a non-annular shape in the above exemplary embodiments, there is no limitation thereto. For example, an annular steering wheel may be employed.

Moreover, although a rearward image from the vehicle 12 is displayed as the first image V1, a left-rearward image from the vehicle 12 is displayed as the second image V2, and a right-rearward image from the vehicle 12 is displayed as the third image V3 in the above exemplary embodiments, there is no limitation thereto. For example, a map of the current location, or another image, may be displayed on the first display section 20, the second display section 22 and the third display section 24.

Moreover, although the gaze detection sensor 42 is provided at the upper end portion of the steering wheel 14 in the second exemplary embodiment and the third exemplary embodiment as illustrated in FIG. 3 and FIG. 6, there is no limitation thereto. For example, a gaze detection sensor may be attached to a non-illustrated rearview mirror.

Further, although the second display section 22 and the third display section 24 are placed in non-display states by default except when being subjected to the gaze of the driver in the second exemplary embodiment, there is no limitation thereto. For example, the first display section 20, the second display section 22, and the third display section 24 may all be set to non-display states, with display only being performed on the respective display sections when being subjected to the gaze of the occupant.

What is claimed is:

1. A vehicle display device, comprising:
a first display section disposed at a vehicle front side of a steering wheel;
a second display section disposed in the vicinity of the first display section at a vehicle left side of the first display section, the second display section being oriented toward a driving seat; and
a third display section disposed in the vicinity of the first display section at a vehicle right side of the first display section, the third display section being oriented toward the driving seat.

2. The vehicle display device of claim 1, wherein:
the first display section is configured to display a vehicle-rearward image;
the second display section is configured to display a vehicle-left-rearward image; and
the third display section is configured to display a vehicle-right-rearward image.

3. The vehicle display device of claim 1, wherein:
the first display section, the second display section and the third display section partially overlap as viewed from the driving seat, and
images displayed at the second display section and the third display section appear continuous with an image displayed at the first display section.

4. The vehicle display device of claim 1, further comprising a gaze detection section configured to detect a line of sight of a driver,
wherein at least one of the first display section, the second display section, or the third display section is placed in a non-display state and displays an image when a direction of the line of sight detected by the gaze detection section corresponds to the at least one of the first display section, the second display section, or the third display section.

5. The vehicle display device of claim 1, further comprising a gaze detection section configured to detect a line of sight of a driver,
wherein brightness is increased for the first display section, the second display section, or the third display section, according to a direction of the line of sight detected by the gaze detection section.

6. The vehicle display device of claim 1, wherein:
the steering wheel is an atypically-shaped steering wheel having a length direction along a vehicle width direction when not being operated, and
grip portions are respectively provided at a left end portion and a right end portion of the steering wheel.
